(19) United States
(12) Patent Application Publication
(10) Pub. No.: US 2007/0088579 A1
(43) Pub. Date: Apr. 19, 2007

(54) Systems and methods for automated processing and assessment of an insurance disclosure via a network

(76) Inventor: John William Richards JR., Evans, GA (US)

Correspondence Address: Christopher J. Chan;SUTHERLAND ASBILL & BRENNAN LLP, 999 Peachtree Street, NE, Atlanta, GA, 30309-3996, US

(21) Appl. No.: 11/504,463

(22) Filed: Aug. 15, 2006

Related U.S. Application Data
(60) Provisional application No. 60/728,163, filed on Oct. 19, 2005.

(51) Int. Cl. G06Q 40/00

(52) U.S. Cl. 705/4

(57) ABSTRACT

The present invention relates to methods and systems for automated processing and assessment of an insurance disclosure. One embodiment of the invention can comprise an automated disclosure processing application engine. The automated disclosure processing application engine can be adapted to receive health care-related information. Health care-related information, also known as a “disclosure,” can include, but is not limited to, a medical claim, a precertification notice, prescription drug history, or any other information related to a medical or insurance claim for reimbursement or payment. Health care-related information can be received at any time, such as in real time, a predefined basis, daily, or on a less or more frequent basis. Health care-related information can be stored in a database, such as a AWAC® database. A portion of the health care-related information can be compared to at least one financial parameter. A portion of the health care-related information can also be compared to at least one clinical parameter. An output can be generated based in part on either the comparison with at least the financial parameter or the clinical parameter.

### RELATED APPLICATION

This application claims priority to U.S. Provisional Ser. No. 60/728,163, entitled “SYSTEMS AND METHODS FOR AUTOMATED PROCESSING AND ASSESSMENT OF AN INSURANCE DISCLOSURE,” filed Oct. 19, 2005, the contents of which are hereby incorporated by reference.

### FIELD OF THE INVENTION

The invention is generally directed to systems and methods for processing insurance information. More particularly, the invention relates to systems and methods for automated processing and assessment of an insurance disclosure via a network.

### BACKGROUND

The health care industry is often criticized for the increasing costs of medical care, products, and services. One reason for the increasing cost of medical care, products, and services is the administrative burden of the increasing amount of paperwork that may be needed to support the decision making process of stakeholders. This process can begin long before an insured seeks health care, and may start before an individual or employer purchases health insurance. Typically, the process begins when an estimate of the utilization of medical care, products, and services is calculated by actuaries or underwriters who may assess the risks of individual members of a health care plan. At some point, an insured, or a provider on the insured's behalf, may file a claim for medical care, products, or services for insurance reimbursement. An administrator of the plan may then ensure that the reimbursement expenses are covered by the plan, and can make appropriate payments to the provider. Various information can be supplied to the insurance company and/or reinsurance carrier for purposes including, but not limited to, reimbursement, audit, setting reserves, and assessing risks on an ongoing basis as well as to set premiums for a subsequent plan year.

Conventional administrative methods can involve periodic transmission of individual claims data, prescription data or precertification data throughout a plan year, or upon request by the insurance, managing general underwriter or reinsurance carrier of summary information via paper reports. Such data is generally transmitted in instances when a catastrophic event such as an expensive diagnosis occurs, when there is a large claim such as a relatively expensive claim, or at a predefined time prior to renewal, such as 90 days prior to expiration of a plan or policy. These conventional processes can be time consuming, such as when reimbursement of a claim paid by an employer is delayed. In other instances, these processes can be expensive, such as when skilled labor is employed to determine which insured's files to review and to further determine which data in files may be relevant or otherwise important.

In other instances, conventional processes can lead to incorrect or incomplete data. Sometimes, there may be an immediate need for information, and errors by personnel in collecting and/or reporting information may result. In some instances, relatively important factual information may be missing or incomplete, which can result in subsequent requests for information. In any instance, missing or incomplete data can result in errors in setting reserves under a particular plan, or may result in inaccurate underwriting of risk for a renewal plan.

Therefore a need exists for improved systems and processes to process and assess an insurance claim or disclosure via a network.

### SUMMARY OF THE INVENTION

Accordingly, systems and processes according to various aspects and embodiments according to the invention address at least some or all of these issues and combinations of them. They do so at least in part by automating processing and assessment of an insurance disclosure via a network.

Specifically, embodiments of the invention can provide a subscriber, such as an insurance underwriter, claims administrator, managing general underwriter, reinsurance carrier, broker, intermediary, employer or third party insurance plan administrator, with information to make decisions related to insuring consumers and assessing risks associated with insuring consumers. Embodiments of the invention can operate via a network and can receive consumer health care-related information, such as medical claim information, precertification data, prescription drug history, medical record information, and medical or diagnostic test results, in the form of an “insurance disclosure.” Subscribers can define parameters such as financial parameters (by way of example, but not limited to financial stop loss or aggregate claims incurred or paid) or clinical parameters (by way of example, but not limited to, clinical codes of concern, ICD9, CPT, HCPCs, DRG codes or drugs) or combinations of financial and clinical parameters (e.g., ICD9 code 178.15 if the claim or total claims incurred total over $75,000 or total claims paid total over $40,000 in the current plan year). Some or all of these parameters can be stored by an embodiment of the invention to process the consumer health care information or insurance disclosure, including associated health care provider information and any insurance disclosure requirements. Embodiments of the invention can also send at least one customized report to a subscriber via email or other modes of communication with a list of insured groups, insureds or claim assessments of an insurance disclosure via a network. Through the network, subscribers can obtain or view the report via an Internet or web browser interface. Via the interface, a subscriber can drill down and analyze the report, including viewing some or all additional detail and associated information for a particular consumer or record.

One purpose of providing disclosure processing is to provide subscribers (Carriers, Managing General Underwriters (MGUs), Third Party Administrators (TPAs), Plan Sponsors, and others) with timely reports and immediate access to on line information that may impact their business. One type of report, for instance, is a “stop loss report.” This type of report can provide a daily list of consumers or insureds who may have exceeded or broken a group-based, subscriber-established, or otherwise predefined stop loss threshold, or an insured-based, subscriber-established, or otherwise predefined stop loss threshold on a daily basis relative to a policy expiration.

Another type of a report can be a “code of concern report.” This type of report can provide a daily list of consumers or insureds who may have a subscriber-established ICD (International Classification of Disease) code, CPT (Current Procedural Technology) code, or dollar amount (or combination thereof) occurrence relative to a policy expiration.

Yet another type of report can be a “customized summary report.” This type of report can summarize some or all information based at least in part on subscriber-established or other predefined criteria. Such reports can be generated and/or transmitted on a regular or predefined basis including, but not limited to, a predefined interval, date, or date relative to a trigger date or regular, predefined or custom-defined trigger occurrence in the data or calculated fields constructed using constants and data.

One aspect of systems and methods according to various embodiments of the invention, focuses on a method for processing and assessment of an insurance disclosure via a network. The method includes receiving health care-related information from at least one data source. Furthermore, the method includes comparing a portion of the health care-related information to at least one financial parameter. Moreover, the method includes comparing a portion of the health care-related information to at least one clinical parameter. Further, the method includes based at least in part on the comparison of the health care-related information to either a financial parameter or clinical parameter, generating an output providing selected health care-related information.

Another aspect of systems and methods according to various embodiments of the invention, focuses on a system for providing processing and assessment of an insurance disclosure via a network. The system includes an automated disclosure processing application engine. The automated disclosure processing application engine is configured to receive health care-related information from at least one data source. Moreover, the automated disclosure processing application engine is configured to compare a portion of the health care-related information to at least one financial parameter. Further, the automated disclosure processing application engine is configured to compare a portion of the health care-related information to at least one clinical parameter. Furthermore, the automated disclosure processing application engine is configured to based at least in part on the comparison of the health care-related information to either a financial parameter or clinical parameter, generate an output providing selected health care-related information

Aspects, features and advantages of various systems and processes according to various embodiments of the present invention can include:

(1) Providing systems and methods for processing and assessing an insurance disclosure via a network;

(2) Providing systems and methods for automatically processing and assessing an insurance disclosure via a network.

(3) Providing systems and methods for automating processing of an insurance disclosure via a network.

Other aspects, features and advantages will become apparent with respect to the remainder of this document.

These example embodiments are mentioned not to limit or define the invention, but to provide examples of embodiments of the invention to aid understanding thereof. Example embodiments are discussed in the Detailed Description, and further description of the invention is provided there.

### BRIEF DESCRIPTION OF THE DRAWINGS

FIG. 1 illustrates an example flowchart for a method in accordance with an embodiment of the invention.

FIGS. 2-4 illustrate examples of login web pages in accordance with an embodiment of the invention.

FIGS. 5-7 illustrate examples of folder hierarchy and organization in accordance with an embodiment of the invention.

FIG. 8-16 illustrate examples of reports, sub-reports, and supporting data in accordance with an embodiment of the invention.

FIGS. 17-18 illustrate examples of web pages associated with data transfer and storage in accordance with an embodiment of the invention.

FIGS. 19-20 illustrate examples of web pages associated with the formatting and output of reports in accordance with an embodiment of the invention.

FIGS. 21-23 illustrate examples of web pages associated with shadowing a user or subscriber in accordance with an embodiment of the invention.

FIG. 24 illustrates an example system in accordance with an embodiment of the invention.

### DETAILED DESCRIPTION

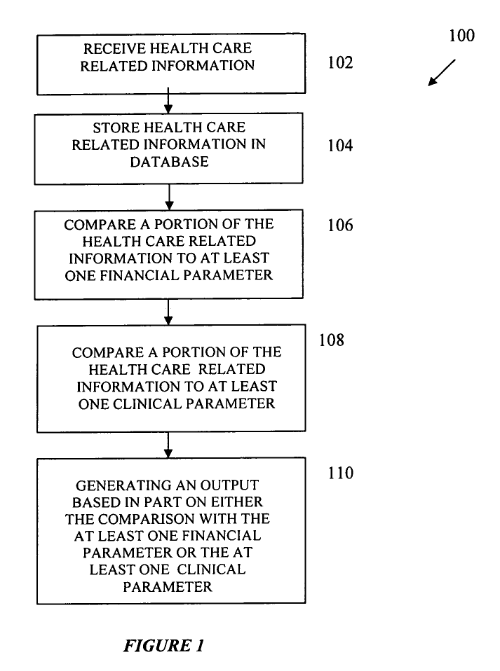

Referring now to the drawings in which like numerals indicate like elements throughout the several figures, FIG. 1 below illustrates a process flow 100 of information during the processing and assessment of an insurance disclosure via a network in accordance with an embodiment of the invention.

The process 100 can permit a user or a subscriber, such as an insurance carrier, third party plan administrator, or another entity, to obtain processed information to make a strategic decision that may otherwise be made with possibly inaccurate or partial data. The process 100 can assist a user or subscriber in filtering information by providing the user or subscriber with the ability to process data using predefined or tailored data thresholds and parameters. These thresholds and parameters can permit a user or subscriber to acquire data needed to address insurance activity and make more accurate risk assessments.

The process 100 begins at block 102. In block 102, health care-related information is received by a subscribing entity, such as a user or subscriber. Health care-related information, also known as a “disclosure,” can include, but is not limited to, medical claim information, precertification data, prescription drug history, medical record information, medical or diagnostic test results, or any other information related to a medical or insurance claim for reimbursement or payment. Health care-related information can be received at any time, such as in real time, a predefined basis, daily, or on a less or more frequent basis.

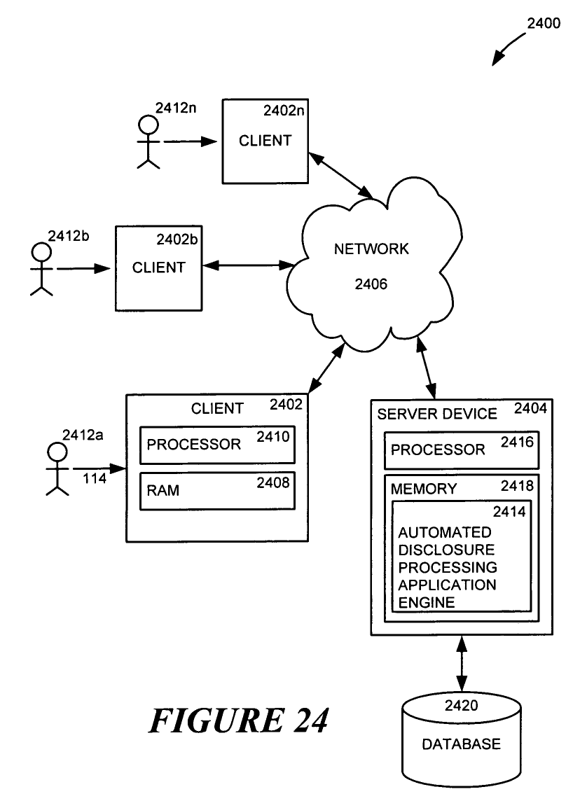

Block 102 is followed by block 104, in which the health care-related information is stored in a database. In this embodiment, the health care-related information is scrubbed, mapped, imported, and stored in a database, such as 2420 in FIG. 24, a AWAC® database, or other data storage device.

Block 104 is followed by block 106, in which a portion of the health care-related information is compared to at least financial parameter. In this embodiment, the health care-related information can be processed by an automated disclosure processing application program, such as 2414 in FIG. 24. A financial parameter can include, but is not limited to, any limit or value as incurred, paid, or otherwise projected to be paid and defined by a group, user, subscriber, insurer, or any other entity. In some instances, a financial parameter can include a band or range of limits or values.

Block 106 is followed by block 108, in which a portion of the health care-related information is compared to at least one clinical parameter. In this embodiment, the health care-related information can be processed by an automated disclosure processing application program, such as 2414 in FIG. 24. A clinical parameter can include, but is not limited to, an ICD9 (International Classification of Disease) code, CPT (Current Procedural Technology) code, HCPC (Healthcare Common Procedure Code), DRG (Diagnostic Related Group) code, alpha descriptor, code of concern, code, drug type or name, an outlier with at least one certain disease or physical characteristic description, or any combination thereof.

Block 108 is followed by block 110, in which an output is generated based in part on either the comparison with the financial parameter or the clinical parameter. In the embodiment shown, an automated disclosure processing application program, such as 2414 in FIG. 24, can facilitate the display of an output via a client device, such as 2402a in FIG. 24, or associated display device by transmitting a suitable signal to the client device 2402a or associated display device.

In one embodiment, generating an output includes providing a graphical user interface capable of displaying selected cost information and provider information.

The process 100 ends at block 110.

In one aspect, medical claims, precertification notices and/or prescription drug history can be received at a database, such as an AWAC® database, on an interval basis (daily or less frequently). The data can be scrubbed, mapped, imported, and stored in a database, such as 2420 in FIG. 24, an AWAC® database, or other data storage device. A preliminary claims analysis can be performed with data from the database 2420, AWAC® database, or other data storage device.

In another aspect, some of all of the following steps can be performed in conjunction with or as part of a method for processing and assessment of an insurance disclosure, including assessing a data load for one or more financial parameters or “stop loss” subscriber defined parameters, and assessing a data load for one or more clinical parameters or “codes of concern” subscriber defined parameters. Either or both of these processes can respectively identify insurance disclosures or claims that meet one or more financial parameter or stop loss and/or clinical parameter or code of concern selection criteria described in the sections below.

For example, a process to assess a data load for group financial parameters or stop loss can be implemented as follows:
Select all insurance claims for an insured in the current load where we have the group's policy period and Stop Loss threshold information defined. The insurance claim is for an Insured, who is in a Group, which is self-administered or under a TPA, which is sponsored by a MGU or Carrier.
FOR EACH such insurance claim:
   Calculate Sum_Of_Claims (Charge & Paid) for the Patient tied to this claim for all his claims in the policy year (group-based, if not insured-based)
   IF Sum_of_Claims for patient is greater than a subscriber defined percentage (e.g., 50%, 75%, 100%) of the Stop Loss value (Group-based, if not insured-based) then
      Record the following information:
      Carrier, TPA, GroupNumber, PolicyBeginDate,
      PolicyEndDate,
      PatientInsuranceNumber, PatientName,
      PercentageThresholdBroken (Charge & Paid),
      LoadDate, LoadID, AWAC_ClaimID,
      ICN, FirstDOS, LastDOS,
      ChargeDate, ChargeAmt, SumChargeToDate
      PaidDate, PaidAmt, SumPaidToDate
      Breaking a percentage of the Stop/Loss threshold is only recorded the first time that percentage is broken for a patient.
   END IF
END FOR

In another example, a process to check clinical parameters such as Check Load For Codes Of Concern can be implemented as follows:
Select all insurance claims, precertifications, and treatments for a Subscriber in the current load that have ICD9 codes and/or CPT codes and/or dollar amounts (or combinations there of) that match a list of subscriber-defined Codes of Concerns for a specific subscriber. The insurance claim, precertification, or treatment is for an Insured, who is in a Group, which is self-administered or under a TPA, which is sponsored by a MGU or Carrier.
FOR EACH such claim:
   Calculate Sum_Of_Claims (Charge & Paid) for the Patient tied to this claim for all his claims in the policy year (group-based)
   Calculate Count_Of_Codes for the Patient tied to this claim for all his claims in the policy year (group-based) that contains the Code of Concern
   Record the following information:
   Carrier, TPA, GroupNumber, PolicyBeginDate, PolicyEndDate,
   PatientInsuranceNumber, PatientName,
   CodeOfConcern,
   LoadDate, LoadID, AWACClaimID,
   ICN, FirstDOS, LastDOS, DaysToPolicyEndDate,
   ChargeAmt, PaidAmt,
   SumChargeToDate, SumPaidToDate, CountOfCodesToDate,
   MinFirstDOS, MaxLastDOS
   A Code of Concern is only recorded the first time it appears in a claim in a policy year for a patient.
END FOR

In another aspect, once disclosure processing is completed, one or more customized reports can be sent to inform subscribers of the previous day's insurance claims that have, for instance, broken or exceeded the stop loss thresholds and that contain or otherwise include codes of concern.

In another aspect, one or more reports, such as a summary report, can be generated with predefined or subscriber-selected data. For instance, a subscriber can select particular data to include in a report, or may select certain sorting or search criteria to select particular data to include in a report.

In yet another aspect, one or more reports can be generated and transmitted on a regular or predefined basis. For instance, a report can be generated and sent on a regular basis, such as every 30, 60, and 90 days after a certain date. In another instance, a report can be generated and sent at other intervals, dates, or dates relative to certain events or trigger events.

For example, a process for generating a report such as a “Report Control” can be implemented as follows:
A report control table is populated at the end of the day based on the reports that need to be run for the subscribers that have subscribed to the Disclosure Reporting service. The control table provides parameters for the reports to run.
   Code of Concern report
   Stop Loss reports
The reports are scheduled to run for each subscriber daily. The parameters drive whether the reports include the period summary portions of the report.

In yet another aspect, one or more summary reports can be scheduled to run at certain intervals relative to the policy expiration, where the periods are subscriber defined.

In another aspect, a web based/browser based window or other graphical user interface associated with an application program can permit real time data viewing and manipulation that can be user or subscriber defined. For example, such a web based/browser based window or other graphical user interface can be associated with an automated disclosure processing application program, such as 2414 in FIG. 24, and the window can be displayed via a client device, such as 2402a in FIG. 24, for viewing by a user, such as 2412a in FIG. 24. Data, such as information associated with one or more insurance claims that exceed or meet a predefined financial parameter such as a stop loss threshold and/or at least one clinical parameter such as a code of concern, can be viewed, manipulated and/or selected by the user 2412a via the window or other graphical user interface.

In another aspect of the invention, various web pages or other user interfaces can be implemented or otherwise facilitated by embodiments of the invention. For example, such web pages or other user interfaces can be associated with an automated disclosure processing application program, such as 2414 in FIG. 24, and the web pages or other user interfaces can be displayed via a client device, such as 2402a in FIG. 24, for viewing by a user, such as 2412a in FIG. 24. Data, such as information associated with one or more insurance claims that exceed or meet a predefined financial parameter such as a stop loss threshold and/or at least one clinical parameter such as a code of concern, can be viewed, manipulated and/or selected by the user 2412a via the web pages or other user interfaces.

Some or all of the processes and aspects described above can be incorporated into one or more application programs, such as an application program known as the iKNOW™ application suite to be distributed by Innovative Health Strategies, Inc. of Augusta, Ga. One embodiment of an application program in accordance with the invention is described below.

An application program in accordance with an embodiment of the invention, such as the iKNOW™ application suite, can provide information in the field of health care. By accumulating and presenting information, the iKNOW™ application suite can provide a relatively secure vehicle for subscribers to make strategic decisions that they may otherwise make with possibly inaccurate or partial data. The iKNOW™ application suite can be directed towards assisting users or subscribers with tailored data thresholds and parameters. These thresholds can allow users or subscribers to acquire some or all of the critical data needed to address insurance activity and make relatively more accurate risk assessments with respect to particular situations.

The iKNOW™ application suite can be implemented, for example, in conjunction with the Citrix Metaframe Access Suite, an advanced remote desktop technology, and Crystal Reports Enterprise architecture distributed by Business Objects. This example implementation can allow for enterprise level report customization, capabilities and features required for or utilized with the robust development standards the iKNOW™ application suite may bring to the health care industry. The data can reside in, for instance, a custom developed Oracle database which may provide suitable performance and reliability.

The iKNOW™ application suite can be accessed by one or more client devices via a web portal, such as the AWAC Web Portal. Access to the portal can occur through 128 bit secure sockets layer HTTPS communication via certificates provided by a web site certification entity, such as Verisign, Inc. By way of example, the web pages below demonstrate a view of an authentication phase, reporting user interface, navigation steps, and reporting features of the iKNOW™ application suite.

In one embodiment, some or all of the information processing can be performed by a Citrix Metaframe Server farm, thus reducing some or all of the need for processing information via a user's client or associated client hardware. This configuration can allow for maintaining a homogenous user experience across a multi-platform client base. This infrastructure landscape can also provide for enhanced on-demand search and reporting features that otherwise would not be possible because of the transmission of relatively large data sets across the Internet or a network, and the processing performed by the client or associated client hardware to sort and present the data. The iKNOW™ application suite can be published via a thin-client architecture. All application changes can be dynamically pushed to one or more clients, and little or no user intervention may be needed in regards to in house upgrades and customizations to the iKNOW™ application suite reports.

In this embodiment, an AWAC Web Portal can provide a user or subscriber with an initial point of access to the iKNOW™ application suite and associated functionality. The user or subscriber can be required to present proper authentication in order to gain access to the AWAC Web Portal. The authentication step can be secured and, in some instances, may not pass credentials in plain text across the Internet or network. Once the user or subscriber has been authenticated by the AWAC Web Portal, the user or subscriber can access, for example, a web page such as a home or introductory page described in more detail below.

Communication between the website and the user or subscriber can be secured with, for example, 128 bit level encryption. Once a user or subscriber is authorized, the user or subscriber can access or otherwise view one or more web pages described as follows.

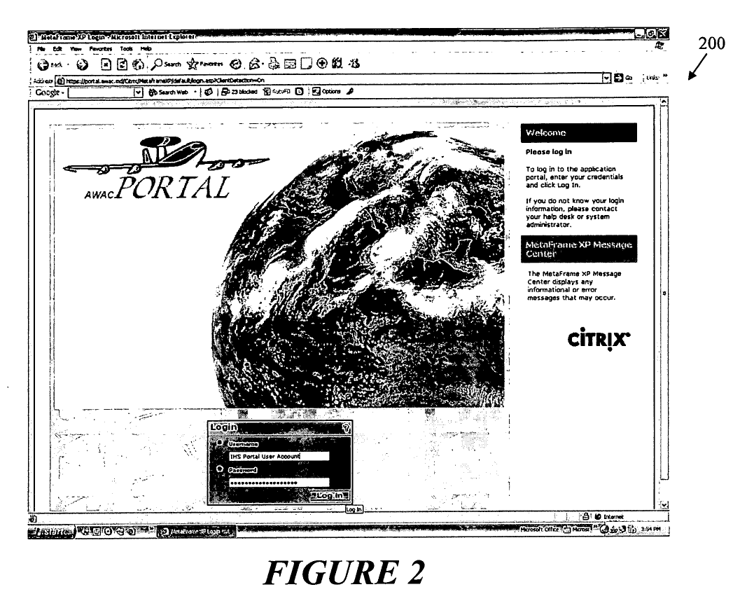

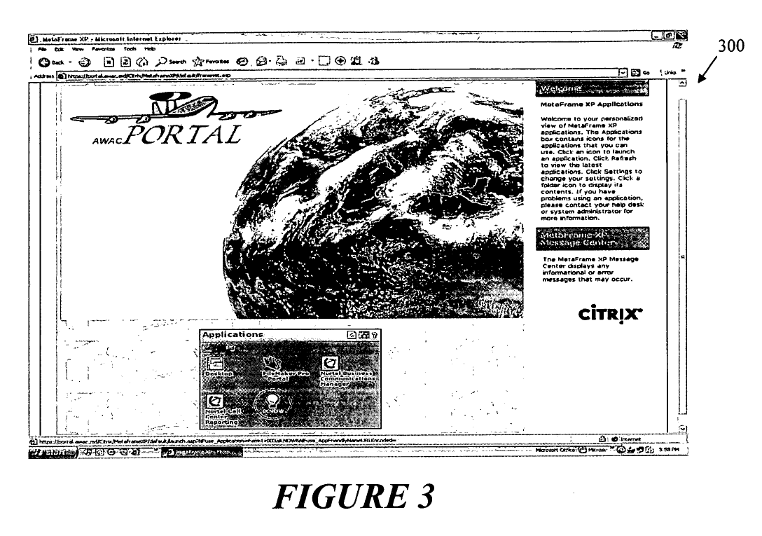

In one embodiment, an initial web page such as a login page illustrated as 200 in FIG. 2 can be accessed. A user or subscriber can be prompted for a separate set of credentials to gain access to a dynamically published application set defined by the user's or subscriber's group access level associated with a user or subscriber login account. As shown in FIG. 3, the user or subscriber can then select an iKNOW™ icon, for example, displayed on the webpage to gain access to the iKNOW™ application suite and associated functionality. Furthermore, double-clicking the iKNOW™ icon can initiate, for example, a Citrix Server connection to facilitate delivering some or all of the functionality of the iKNOW™ application suite via logon to an associated Citrix Server Farm. The user or subscriber can be presented with a dialog box, such as an Innovative Health Strategies internal certification acceptance dialog box, for communication between the Citrix Server and a server, such as the iKNOW™ application program server. The user or subscriber can select YES to both dialog boxes in order to proceed to an iKNOW™ webpage home page.

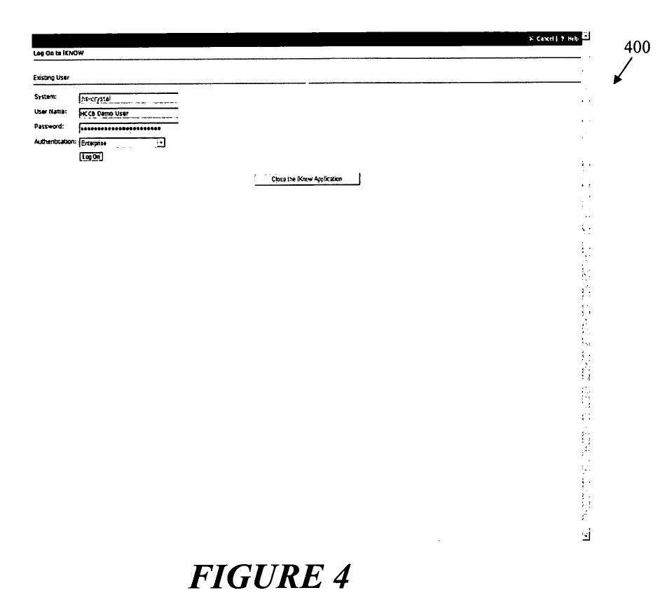

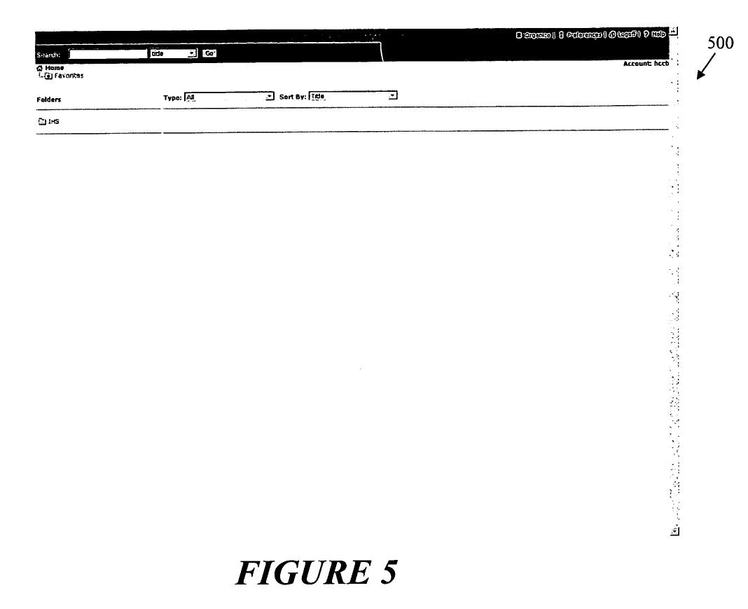

Continuing from the example above, an iKNOW™ login screen, shown as 400 in FIG. 4, can be displayed and prompt the user or subscriber for application account information. Entering the authenticated account information can prompt the display of the main iKNOW screen at the root user folder level. Each user or subscriber account can have a root folder. For example, as shown in FIG. 5, the IHS (Innovative Health Strategies) folder structure 500 can be a common root folder which is presented to some or all users or subscribers.

Single-clicking on a particular folder structure can permit a user or subscriber to drill down into the next or adjacent folder level structure until reaching a lower level displaying one or more report objects. The report objects can be parameterized by the account information provided at login. In some instances, the respective user or subscriber's account may display appropriate or particularized data for that user or subscriber's account.

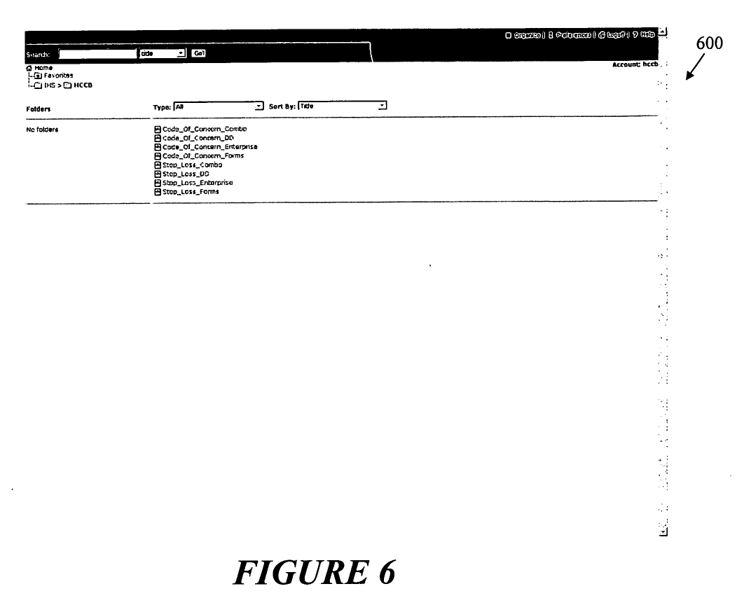

FIG. 6 illustrates an example series of report objects 600 associated with a folder structure in accordance with an embodiment of the invention. In this example, report objects can include, but are not limited to, “Code of Concern Combo”, “Code of Concern DD”, “Code of Concern Enterprise”, “Code of Concern Forms”, “Stop Loss Combo”, “Stop Loss DD”, “Stop Loss Enterprise”, and “Stop Loss Forms”. Other embodiments of the invention can include fewer or greater numbers of report objects as well as different report objects.

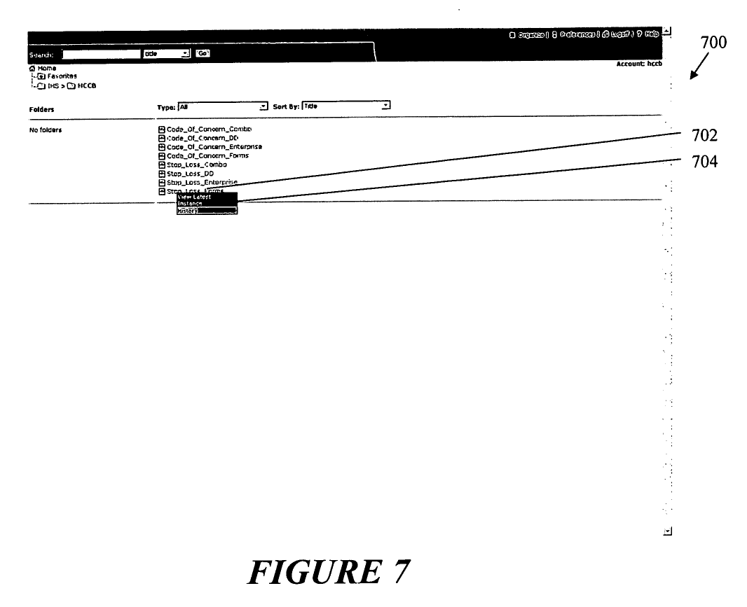

As shown in FIG. 7, single-clicking on a report object, such as “Stop Loss Forms” 702, can bring up a cascade menu selection 704 which can allow users or subscribers to view, for example, the latest prescheduled report instance, a list of some or all instances of a report, or a history of some or all reports. An instance of a report is a data snapshot of a particular point in time of the report. The user or subscriber can go back in time as far as the specified control settings may provide, which can be established by or otherwise modified by the administrator. In an environment where data may change from day-to-day and a daily record must or is desired to be maintained, this technology can provide users or subscribers with suitable control. In some instances, additional selections may be or may not be granted to users or subscribers including, but not limited to, scheduling capability, management of instances, and run on demand. By single-clicking on one of the instance time-stamps, the application suite can load the corresponding report instance and stored data set.

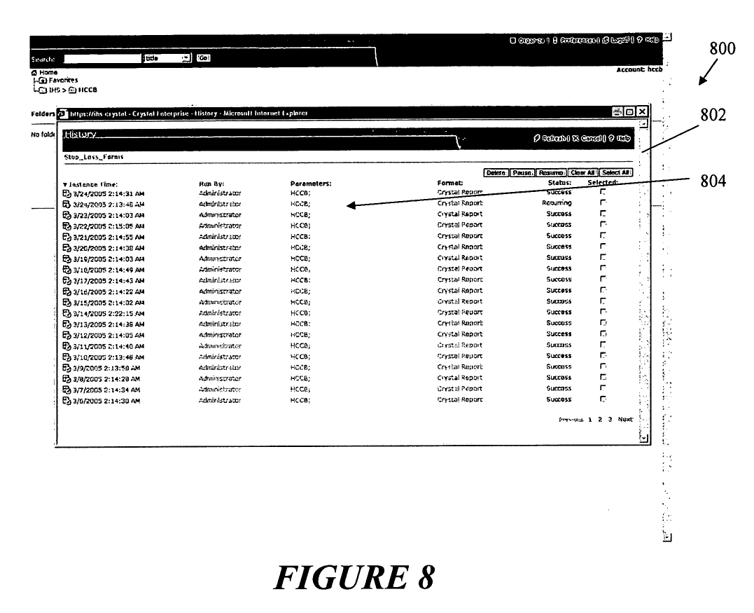

FIG. 8 is an example web page 800 with an example report. Continuing from the example above in FIG. 7, a user or subscriber can select from the cascading menu a selection such as “History.” As shown in FIG. 8, a report 802 can provide data, such as historical-type data 804, or other data, such as responsive to pre-specified control settings.

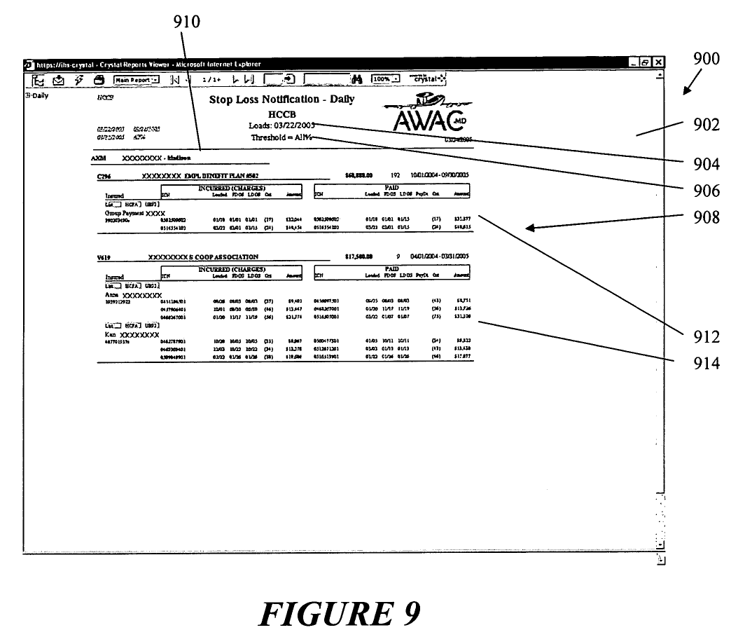

FIG. 9 is an example web page 900 with another example of a report, such as a stop loss report. As shown in FIG. 9, a report 902 can indicate a particular set of data, such as a data load 904, and a threshold 906. Output 908 generated by the system, such as 100, in response to a particular threshold, such as 906, can be displayed in subsequent fields 910, 912, 914 organized by predefined categories, sub-categories, or other classifications. Other reports can include other parameters such as a financial and/or clinical parameters, data loads, thresholds, and outputs in accordance with an embodiment of the invention.

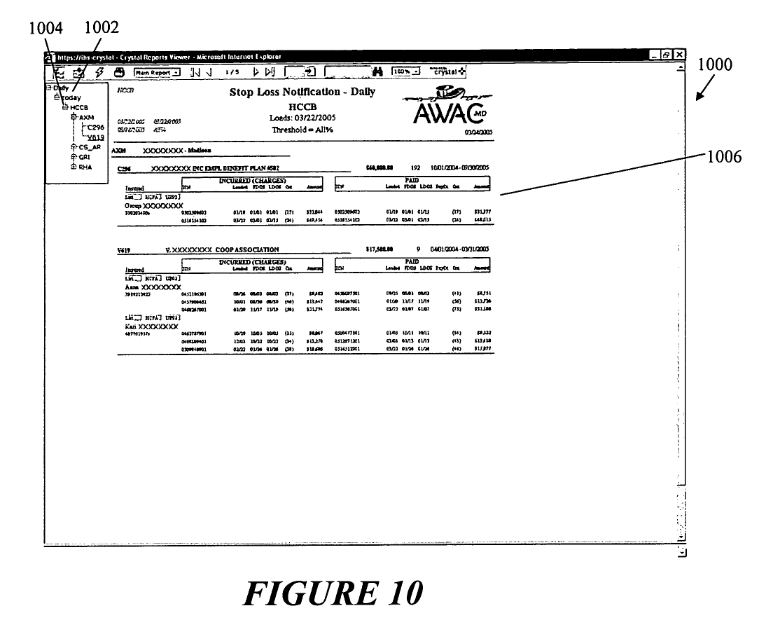

In one embodiment, one or more reports can be generated, and a user or subscriber can navigate through the data of some or all of the reports. For example, reports, such as a stop loss report and a disclosure report, and their associated data can be navigated using associated functionality of the iKNOW™ application suite. Navigation of reports being presented with a web embedded report viewer or other navigational tool or device, such as a web browser, can have similar or otherwise common navigational bar icons and functions. For example, as shown in FIG. 10, navigation drill-down functionality 1000 can be presented in a left window pane 1002 at some or all times by default. An icon 1004 located at the upper left of the report viewer can permit a user or subscriber to turn this feature off if the user or subscriber requires or needs more viewable area on the output device or display screen. In this example, by single-clicking the plus icon 1004 at the left of the hierarchy structure, the user or subscriber has the ability to drill down to the bottom level of the structure that meets the search requirements. The sort groups can represent the hierarchy structure that is displayed and is automatically coded into the format of the report. In some instances, no further user or subscriber action may be needed to enable this feature after the report has been executed or otherwise generated. The display of the report data set viewable in the right pane 1006 can follow the corresponding level of hierarchy that the user or subscriber has currently navigated to.

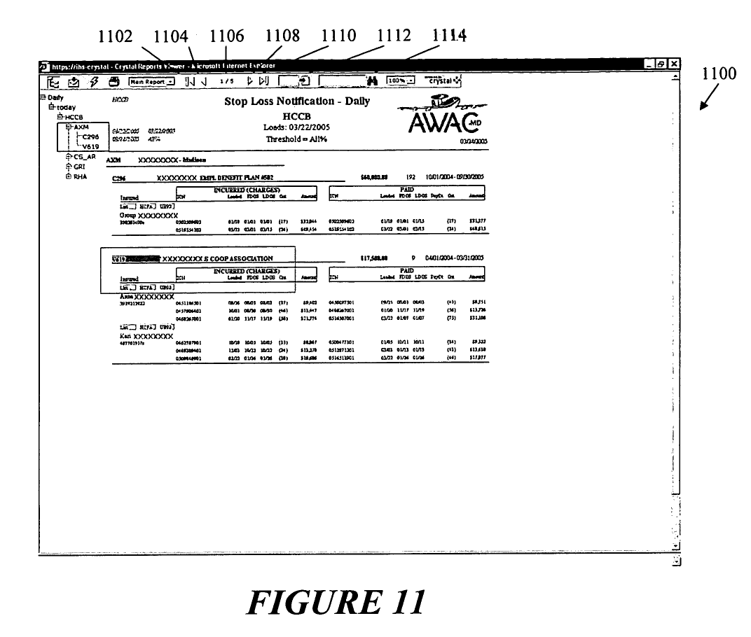

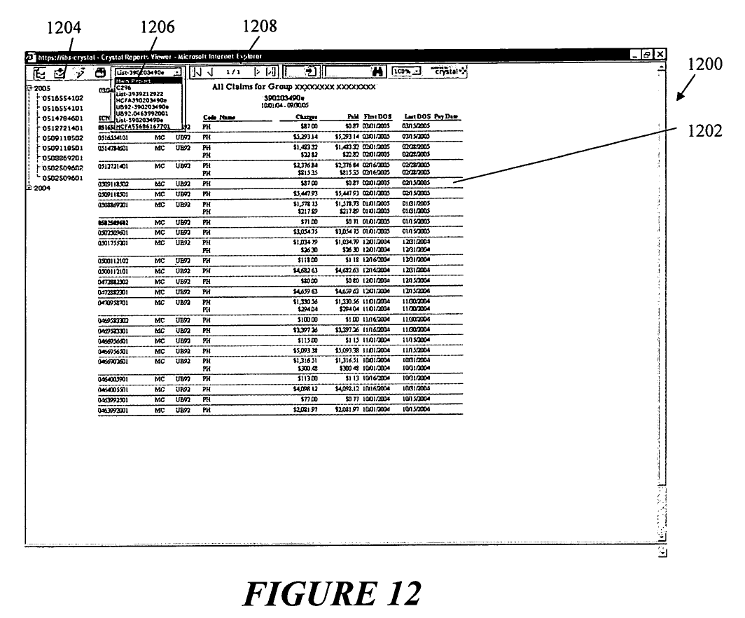

In another example, a user or subscriber may also navigate a report by utilizing the navigation arrows across the top of the embedded report viewer or other navigational tool or device, such as a web browser. As shown in FIG. 11, from left to right, example buttons 1102, 1104, 1106, 1108 for an embedded report viewer may be as follows: (1) Go to first page of report; (2) Go to previous page of report; (3) Go to next page of report; and (4) Go to last page of report. The user or subscriber may also enter a specific page number in the text window and single-click the “Go to Specific Page” icon 1110, for instance, portrayed as a sheet of paper with a red arrow pointing to the right. The user or subscriber may also enter search criteria in order to navigate or locate specific points of interest within the report by imputing the parameter and single-clicking the binoculars-shaped icon 1112, for instance. The user or subscriber may also adjust the size of the report in the right pane of the viewer with the percentage drop down tool 1114, for instance, in the navigational toolbar. Some or all of the functionality described above is also illustrated in the series of web pages with other types of reports shown in FIGS. 12, 13, 14, and 15 described below.

FIG. 12 illustrates an example of another web page 1200 with another example report in accordance with an embodiment of the invention. The web page 1200 includes a report 1202 with a navigational bar 1204 with buttons associated with navigational-type functionality. As a user or subscriber drills down into a report 1202 or sub-report, a drop down box 1206 located to the left of the navigational icons “arrows” 1208 can permit a user or subscriber to jump between levels of viewer windows showing different reports, sub-reports, or different aspects of the same report or sub-report. In this manner, a user or subscriber can jump from one detail level to another detail level once he or she has drilled past the scope of bottom tier of the left pane navigation hierarchy. This drop down box 1206 can provide a user or subscriber the ability to jump back to previous details, report positions, or to the main report window. To completely exit a report within the application suite, a user or subscriber can click a “X” icon located at the top right of the navigational bar 1204. This action may not close the application suite but it can permit a user or subscriber to navigate back to the instance list or report object list depending on whether the user or subscriber is viewing an on-demand report or a prescheduled instance.

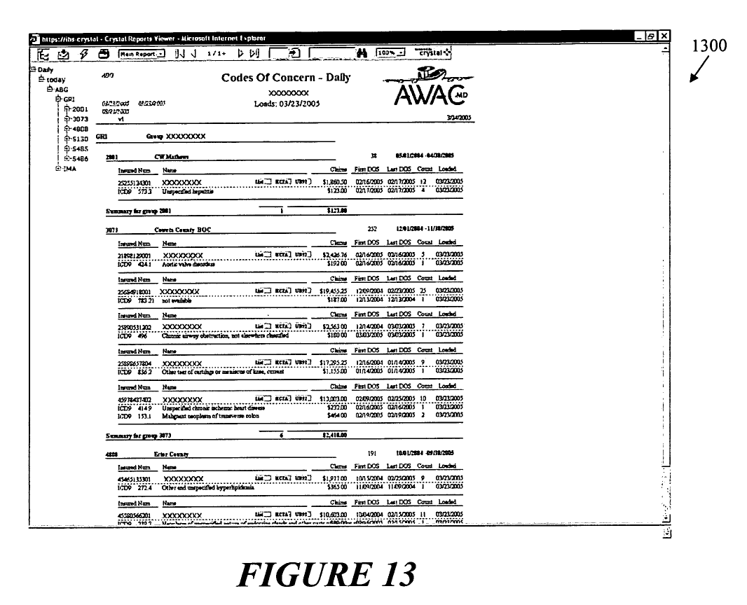

Each report can have in each record set a group of links labeled, for instance, in blue color, and named, for instance, “List”, “HCFA”, and “UB92”. If the data dictates these parameters, these links can navigate the user or subscriber to the sub-report. Single-clicking the links can bring sub-reports containing even greater detail data into the viewer window in either a list or image format. An example of a list format for a sub-report with links to various record sets is shown in the web page 1300 shown in FIG. 13.

Examples of links can be defined as follows: “List”—Lists all records matching a particular data element, i.e., claimant; “HCFA”—Displays all matching data in HCFA (Health Care Financing Administration) format presented as a printable image which is populated automatically with the data set; and “UB92”—Displays all matching data in UB (Universal Billing Code) format presented as a printable image which is populated automatically with the data set. The HCFA and UB92 (Uniform Billing Code of 1992) images may be standardized which can allow for the presentation of the supporting data in a customary layout.

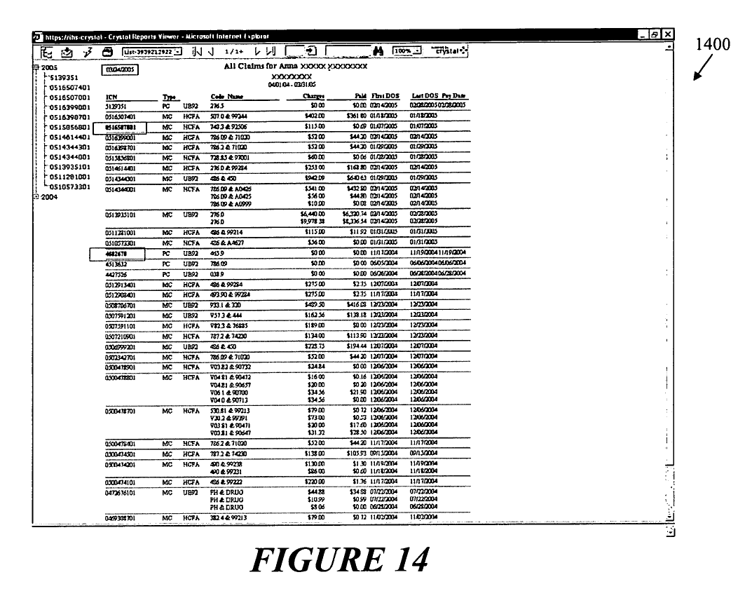

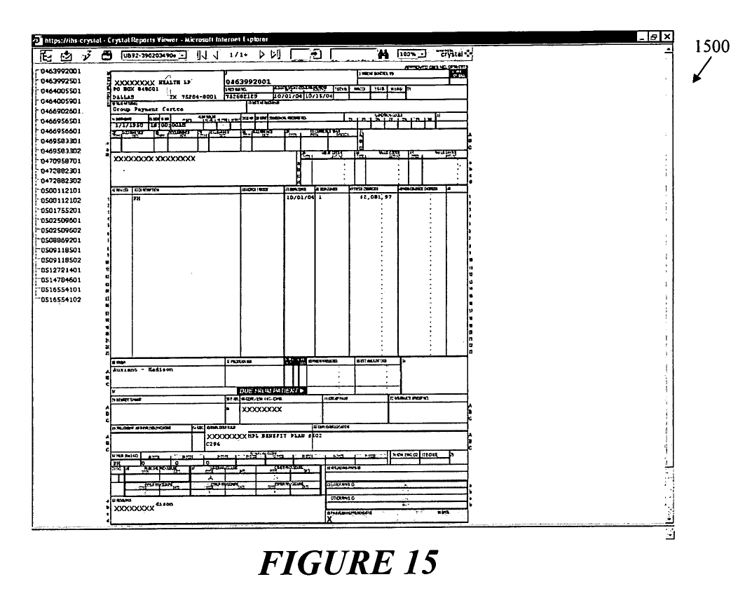

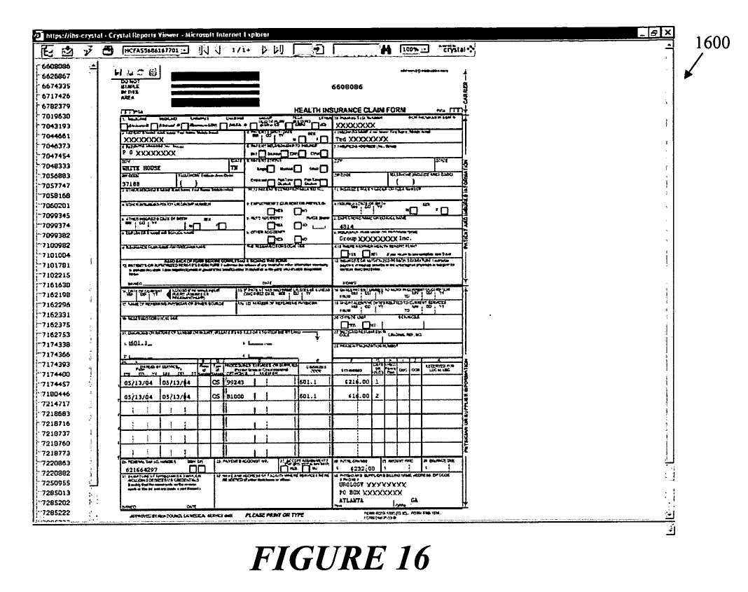

FIGS. 14, 15, and 16 illustrate examples of other types of data that can be provided in accordance with an embodiment of the invention. FIG. 14 is an example of a report with disclosure-related data for a particular patient or entity. FIG. 15 is an example of a payment invoice which may be provided as supporting data in accordance with an embodiment of the invention. FIG. 16 is an example of a health insurance claim form which may be provided as supporting data in accordance with an embodiment of the invention.

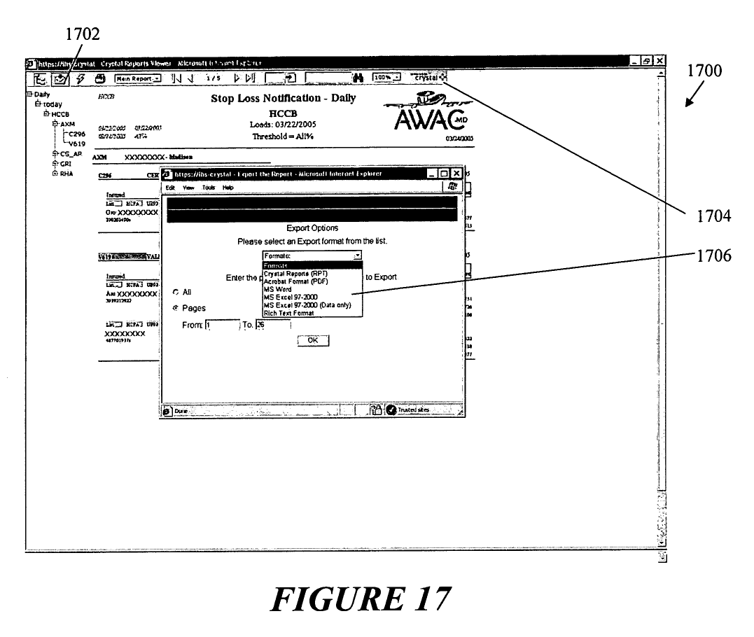

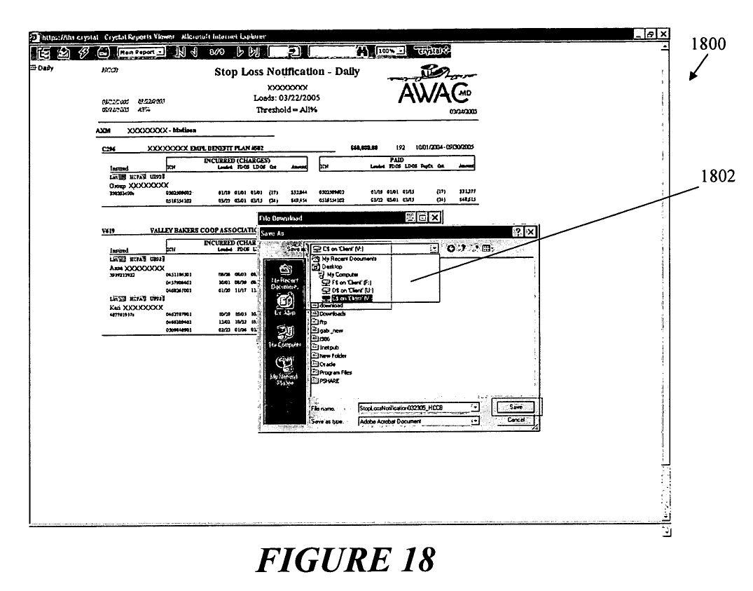

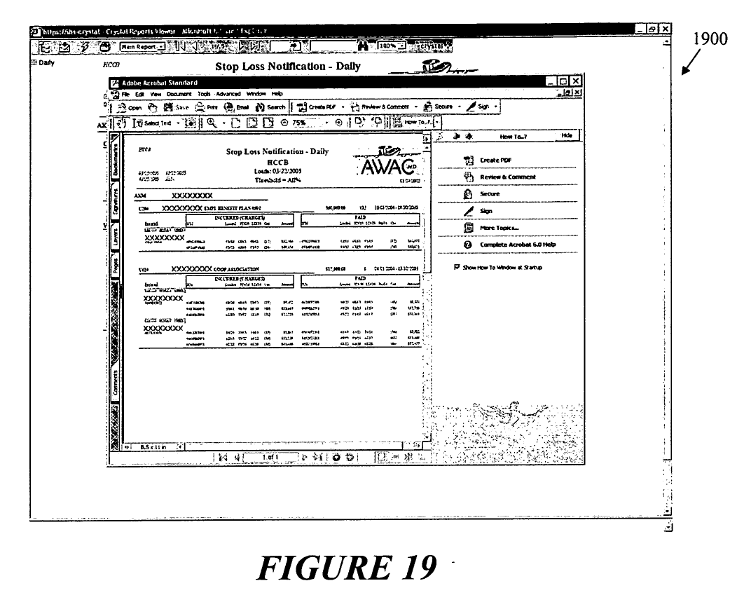

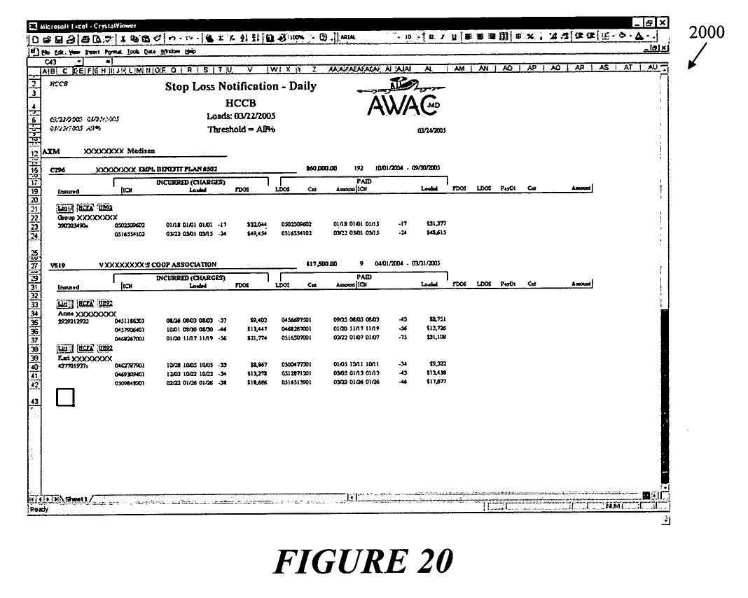

In one embodiment, some or all of the data described above can be exported by the iKNOW™ application suite or associated functionality. For example in FIG. 17, an icon 1702 located in the upper left of the navigation toolbar 1704 portrayed as an envelope with a red arrow pointing down can initiate the export feature within the iKNOW™ application suite. As shown in the window 1706 of FIG. 17, various business-standard export formats, such as Adobe PDF, Crystal Reports RPT, Microsoft Word, Microsoft Excel, RTF, etc., can be available for exporting a report to another application, program, or computer-readable media. As shown in the webpage 1800 of FIG. 18, a window 1802 can provide a user or subscriber with a choice of locations during the export process, such as the user or subscriber's local hard drive, to transmit exported data to. For quality assurance purposes, the capability of viewing exported data while still being logged into the iKNOW application suite can provide an advantage to the user or subscriber. Examples of an Adobe PDF and a Microsoft Excel formatted report 1900, 2000 are shown in FIGS. 19 and 20 respectively.

In another embodiment, a user or subscriber can log off of the iKNOW™ application suite. For instance, a user or subscriber can exit back to the root folder screen via the “X” icon in the upper right of the navigational bar where the Logoff link is presented in the top right. A user or subscriber can single-click on the Logoff link, which can lead back to the main logon screen. Single-clicking on the “Close the iKNOW Application” button can log the user or subscriber off the Citrix Server Farm and return him or her to the secure portal screen at which time he or she is provided the ability to enter other published applications or to exit the secure portal entirely.

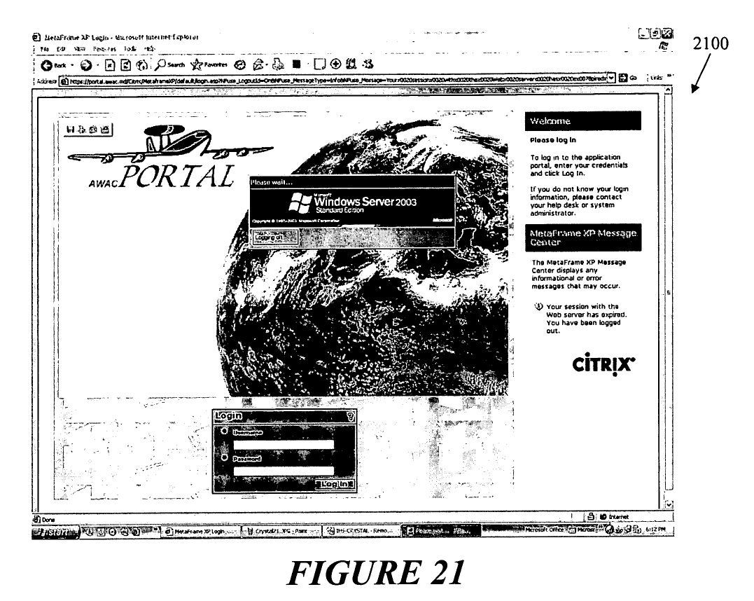

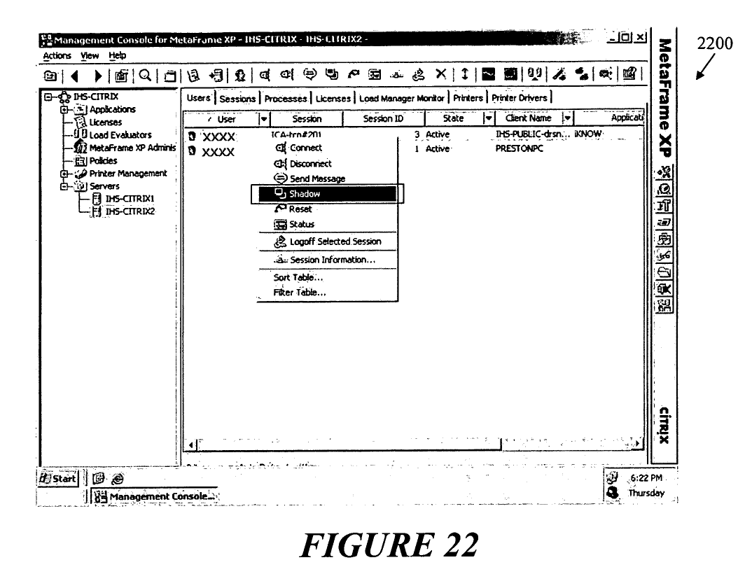

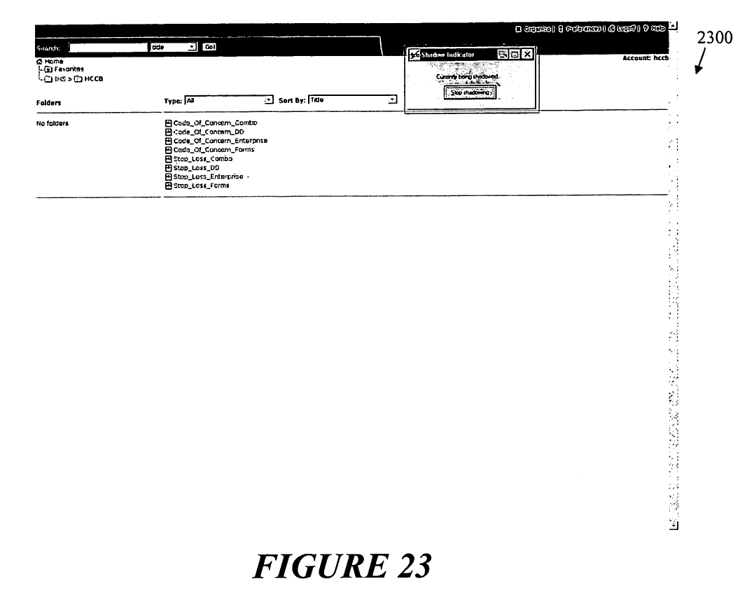

In yet another embodiment, the iKNOW™ application suite can provide shadowing and user training functionality. The infrastructure can lend itself to the ability for support staff and business staff whether onsite or offsite to conduct training and shadowing of users for troubleshooting and/or guidance. Some or all of this interactive process is displayed in the web pages 2100, 2200, 2300 illustrated in FIGS. 21, 22, and 23 respectively.

Other examples of screenshots or user interfaces can be implemented or otherwise facilitated by an automated disclosure processing application engine and associated functionality in accordance with other embodiments of the invention. The above examples are intended to be by way of example, and are not intended to limit the scope of the invention.

FIG. 24 is an illustration of example system components for a system in accordance with an embodiment of this invention. The system 2400 shown in FIG. 24 comprises multiple client devices 2402a-n in communication with a server device 2404 over a network 2406. The network 2406 shown can comprise the Internet, an automated or electronic insurance data network, any other suitable network, or a combination of such networks. In other embodiments, other networks, wired and wireless, such as an intranet, local area network, wide area network, or broadcast network may be used. Moreover, methods according to the present invention may operate within a single client or server device. In the example shown, the method 100 illustrated in FIG. 1 can be implemented by the system 2400.

Each client device 2402a-n shown in FIG. 24 preferably comprises a computer-readable medium. The computer-readable medium shown can comprise a random access memory (RAM) 2408 coupled to a processor 2410. The processor 2410 can execute computer-executable program instructions stored in the memory 2408. Such processors may comprise a microprocessor, an Application-Specific Integrated Circuit (ASIC), a state machine, or other processor. Such processors comprise, or may be in communication with, media, for example computer-readable media, which stores instructions that, when executed by the processor, cause the processor to perform the steps described herein.

Embodiments of computer-readable media may comprise an electronic, optical, magnetic, or other storage or transmission device capable of providing a processor, such as the processor 2410 of client 2402a, with computer-readable instructions. Other examples of suitable media may comprise a floppy disk, Compact Disk Read Only Memory (CD-ROM), magnetic disk, memory chip, Read Only Memory (ROM), Random Access Memory (RAM), an ASIC, a configured processor, all optical media, all magnetic tape or other magnetic media, or any other suitable medium from which a computer processor can read instructions or on which instructions, code, or other data may be stored. Also, various other forms of computer-readable media may transmit or carry instructions to a computer, including a router, private or public network, or other transmission device or channel, both wired and wireless. The instructions may comprise code from any suitable computer-programming language, including but not limited to, for example, C, C++, C#, Visual Basic, Java, Python, Perl, and JavaScript.

Client devices 2402a-n may also comprise a number of external or internal devices such as a magnetic or smart card reader, biometric data collection devices, mouse, a CD-ROM, a keyboard, a display, or other input or output devices. Examples of client devices 2402a-n are card terminals, personal computers, media center computers, televisions, television set-top boxes, digital assistants, personal digital assistants, cellular phones, mobile phones, smart phones, pagers, digital tablets, laptop computers, Internet appliances, and other processor-based devices. In general, a client device 2402a-n may be any type of processor-based platform that may be connected to a network 2406 and that interacts with one or more application programs. Client devices 2402a-n may operate on any operating system, such as Microsoft® Windows®, Macintosh, Unix, or Linux, capable of supporting one or more client application programs. For example, the client device 2402a shown comprises a personal computer executing client application programs, also known as client applications. The client applications can be contained in memory 2408 and can comprise, for example, an Internet browser application, and any other application or computer program capable of being executed by a client device.

Each of the client devices 2402a-n can be associated with a respective subscribing entity or subscriber, such as a carrier, a managing general underwriter (MGU), a third party administrator (TPA), or a plan sponsor, shown as users 2412a-n. Through the client devices 2402a-n, users 2412a-n can communicate over the network 2406 with each other and with other systems and devices coupled to the network 2406. As shown in FIG. 2, a server device 2404 is also coupled to the network 2406. For example in the embodiment shown in FIG. 24, a user 2412a can operate a respective client 2402a to interact with the server device 2404 and formulate a request for processing an insurance disclosure. The client 2402a can send a signal corresponding to the request via the network 2406 to the server 2404.

The server device 2404 shown in FIG. 24 comprises a server executing at least one automated disclosure processing application program, also known as the automated disclosure processing application engine 2414 or automated disclosure processing program. Similar to the client devices 2402a-n, the server device 2404 shown in FIG. 24 comprises a processor 2416 coupled to a computer-readable memory 2418. Server device 2404, depicted in FIG. 24 as a single computer system, may be implemented as a network of computer processors. Examples of a server device are servers, mainframe computers, networked computers, a processor-based device, and similar types of systems and devices. Client processors 2410 and the server processor 2416 can be any of a number of well known computer processors, such as processors from Intel Corporation of Santa Clara, Calif. and Motorola Corporation of Schaumburg, Ill.

Memory 2418 on the server device 2404 can contain the automated disclosure processing application engine 2414. An automated disclosure processing application engine 2414 can comprise a software or hardware application that is configured to automatically process and assess an insurance disclosure. In one embodiment, an automated disclosure processing application engine 2414 can be the IKNOW™ software program to be operated by Innovative Health Strategies, Inc., of Augusta, Ga. In response to a request for assessment of an insurance disclosure from a user 2412a operating a client 2402a, the automated disclosure processing application 2414 shown in FIG. 24 can begin processing and assessing an insurance disclosure.

The server device 2404 can also communicate with at least one database 2420, such as an insurance database, to retrieve and/or store information associated with processing and assessing an insurance disclosure. The database 2420 can comprise one or more storage devices with insurance information, or any other information which can be used to assess an insurance disclosure.

Although the processes described herein are described in relation to the client and server or servers, a client may perform any or all of the processes described as being performed by a server. Similarly, a server or servers may perform any or all of the processes described herein as being performed by a client, although the invention is not limited to client/server architecture but can run on any desired topology or architecture as deemed fit for the purposes, whether existing as of the time of the writing of this document or thereafter.

Embodiments of the present invention can comprise systems having different architecture than that which is shown in FIG. 24. For example, in some systems according to the present invention, server device 2404 may comprise a single physical or logical server. The system 2400 shown in FIG. 24 is merely an example, and is used as an environment to help explain the example processes and methods shown in FIG. 1.

As shown in FIG. 24, an example automated disclosure processing application engine 2414 can include one or more functional components to accomplish some or all of the following functionality: assessing and comparing health care-related data based in part on at least a financial or stop loss parameter, and assessing and comparing health care-related data based in part on at least a clinical or code of concern parameter. Other functions, components, modules, or sub-components for an automated disclosure processing application engine 2414 can exist.

In the embodiment shown in FIG. 24, the automated disclosure processing application engine 2414 can provide a user interface for use of the automated disclosure processing application engine 2414 by users 2412a-n via the network 2406. The user interface can provide users 2412a-n with on-line accessibility to details of a particular disclosure assessment, and on-line functionality of the automated disclosure processing application engine 2414. The automated disclosure processing application engine 2414 can also provide a user interface for a user 2412a-n to interact with the automated disclosure processing application engine 2414.

In one embodiment, an automated disclosure processing application engine 2414 can include a financial parameter or stop loss module adapted to assessing and comparing health care-related data based in part on at least a financial parameter or stop loss parameter. The financial parameter or stop loss module can collect and utilize insurance data associated with customers such as businesses, governments, and other entities. Data can be stored in and/or accessed from one or more associated databases, such as database 2426, an insurance database, or any other suitable database or data storage device.

In yet another embodiment, an automated disclosure processing application engine 2414 can include a clinical parameter or code of concern module adapted to assess and compare health care-related data based in part on at least a clinical parameter or code of concern parameter.

In another embodiment, an automated disclosure processing application engine 2414 can include a customized report module adapted to facilitate transmission of a customized report to inform a subscriber of a previous day's claims that have met or exceeded a financial parameter such as a stop loss threshold and that may contain a clinical parameter such as one or more codes of concern.

In another embodiment, an automated disclosure processing application engine 2414 can include a summary report module adapted to facilitate transmission of a summary report to a inform a subscriber at any predefined time, such as scheduling a report at certain intervals relative to a policy expiration, where the time periods are subscriber defined.

Examples of a user interface for a subscriber to interact with a disclosure processing application program according to an embodiment of the invention are illustrated above.

Collectively, the components of the automated disclosure processing application engine 2414 can process an insurance disclosure and coordinate the transfer of information and an assessment between entities. Users 2412a-n can focus more on deciding whether a particular claim from a medical claimant is a valid claim.

Example methods that can be performed by an automated disclosure processing application engine, in accordance with embodiments of the invention, are illustrated in FIG. 1. The methods shown in FIG. 1 can be implemented in conjunction with the example system 2400 shown in FIG. 24. This method and other methods can be performed or otherwise implemented on other system embodiments in accordance with other embodiments of the invention.

While the above description contains many specifics, these specifics should not be construed as limitations on the scope of the invention, but merely as exemplifications of the disclosed embodiments. Those skilled in the art will envision any other possible variations that are within the scope of the invention.

The claimed invention is:

1. A method for processing and assessment of an insurance disclosure via a network comprising:
receiving health care-related information from at least one data source;
comparing a portion of the health care-related information to at least one financial parameter;
comparing a portion of the health care-related information to at least clinical parameter; and
based at least in part on the comparison of the health care-related information to at least a financial parameter or clinical parameter, generating an output providing selected health care-related information.

2. The method of claim 1, wherein receiving health care-related information from at least one data source, comprises:
receiving health care-related information from at least one disclosure source; and
storing the health care-related information in at least one data storage device.

3. The method of claim 1, wherein the at least one data source includes data comprising at least one of the following: medical claim information, precertification data, prescription drug history, medical record information, medical or diagnostic test results, information associated with a medical insurance claim for reimbursement, information associated with a medical insurance claim for payment, or information associated with at least one medical insurance claim.

4. The method of claim 1, wherein generating an output providing selected health care-related information comprises:
filtering the health care-related information against at least financial parameter or clinical parameter.

5. The method of claim 1, wherein the financial parameter comprises at least one of the following: a limit; a value; a range of values; or a range of limits.

6. The method of claim 1, wherein the clinical parameter comprises at least one of the following: an ICD, CPT, HCPC, DRG, alpha descriptor, outlier, or any combination thereof.

7. The method of claim 1, further comprising:
receiving a request for a comparison from at least one client.

8. The method of claim 7, wherein receiving a request for a comparison from at least one client comprises:
receiving an instruction to provide comparative information associated with at least one financial parameter; and
receiving an instruction to provide comparative information associated with at least one clinical parameter.

9. The method of claim 1, wherein generating an output providing selected health care-related information comprises providing a graphical user interface capable of displaying selected health care-related information.

10. A system for providing processing and assessment of an insurance disclosure via a network comprising:
an automated disclosure processing application engine configured to
receive health care-related information from at least one data source;
compare a portion of the health care-related information to at least one stop loss threshold;
compare a portion of the health care-related information to at least one code of concern; and
based at least in part on the comparison of the health care-related information to at least a financial parameter or clinical parameter, generate an output providing selected health care-related information.

11. The system of claim 10, further comprising:
a financial parameter module configured to
assess health care related data based on at least one predefined financial parameter.

12. The system of claim 10, further comprising:
a clinical parameter module configured to
assess health care-related data based on at least one predefined clinical parameter.

13. The system of claim 10, further comprising:
a report module configured to:
prepare a summary report, wherein the summary report comprises selected health care-related information; and
transmit the summary report to a client.

14. The system of claim 10, wherein receive health care-related information from at least one data source comprises:
receiving health care-related information from at least one disclosure source; and
storing the health care-related information in at least one data storage device.

15. The system of claim 10, wherein the at least one data source includes data comprising at least one of the following: medical claim information, precertification data, prescription drug history, medical record information, medical or diagnostic test results, information associated with a medical insurance claim for reimbursement, information associated with a medical insurance claim for payment, or information associated with at least one medical insurance claim.

16. The system of claim 10, wherein generate an output providing selected health care-related information comprises:
filtering the health care-related information against at least one financial parameter or clinical parameter.

17. The system of claim 10, wherein the financial parameter comprises at least one of the following: a limit; a value; a range of values; or a range of limits.

18. The system of claim 10, wherein clinical parameter comprises at least one of the following: an ICD, CPT, HCPC, DRG, alpha descriptor, outlier, or any combination thereof.

19. The system of claim 10, wherein the automated disclosure processing application engine is further configured to:
receive a request for a comparison from at least one client.

20. The system of claim 10, wherein receive a request for a comparison from at least one client comprises:
receiving an instruction to provide comparative information associated with at least one financial parameter; and
receiving an instruction to provide comparative information associated with at least one clinical parameter.

21. The system of claim 10, wherein generate an output providing selected health care-related information comprises providing a graphical user interface capable of displaying selected health care-related information.
